(19) United States
(12) Patent Application Publication
(10) Pub. No.: US 2022/0027444 A1
(43) Pub. Date: Jan. 27, 2022

(54) METHOD AND SYSTEM FOR AUTOMATED USER AUTHENTICATION BASED ON VIDEO AND AUDIO FEED IN REAL-TIME

(71) Applicant: Signzy Technologies Private Limited, Mumbai (IN)

(72) Inventors: Aadalarasan Bhavani SARAVANAN, Mumbai (IN); Shiv Shankar SUBUDHI, Mumbai (IN); Sidharth PATTNAIK, Mumbai (IN); Chitrangada PATRA, Mumbai (IN); Dinesh AVULA, Mumbai (IN); Ankit RATAN, Mumbai (IN); Arpit RATAN, Mumbai (IN); Ankur PANDEY, Mumbai (IN)

(73) Assignee: Signzy Technologies Private Limited, Mumbai (IN)

(21) Appl. No.: 17/125,973

(22) Filed: Dec. 17, 2020

(51) Int. Cl. G06F 21/32; G06F 21/40; G06F 21/31; H04L 29/06

(52) U.S. Cl. CPC G06F 21/32; H04L 63/0861; G06F 21/316; G06F 21/40

(57) ABSTRACT

The present disclosure provides a method and system for automated user authentication based on video and audio feed in real-time. The system receives a user data from one or more users. In addition, the system analysis the user data. Further, the system matches lips movement of the one or more users for given text or phrase. Furthermore, the system syncs audio feed with video feed of the one or more users. Moreover, the system receives a response to captcha given to the one or more users. Also, the system performs facial matching of the one or more users based on the user data. Also, the system detects original user from the one or more users. Also, the system sends an outcome of the detected original user from the one or more users to one or more financial technology organizations.

### TECHNICAL FIELD

The present invention relates to user authentication and, in particular, to a method and system for automated user authentication based on video and audio feed in real-time.

### INTRODUCTION

In recent times, many of the companies provide a facility to a user to keep important documents safe and secure. The user can safeguard important documents using various security parameters provided by the companies. With the advancement in Artificial Intelligence and Machine Learning sectors various security parameters have been introduced. Technological developments made the humongous amount of controls available for digital security that includes tokens, biometrics, encryption, facial matching, user authentication and the like. The basic element of security services is user authentication, that verifies identity of the user. In addition, the user authentication is the assurance of the identity of the end-user to the service provider, such as a commercial, financial or official institution. The financial institutions include banks, financing companies, government organizations, and the like. Also, the user authentication process has improved the security aspects in financial technology space. The user authentication process has limit the financial crimes in society. Also, the user has to go through various steps to gain access to his/her account and/or documents. Nowadays, the authentication systems that exist performs limited amount of authentication processes. There is no complete authentication system that authenticates the user in every aspect.

### SUMMARY

In a first example, a computer-implemented method is provided. The computer-implemented method for real-time advertisement auction on telecommunication notification channels. The computer implemented method corresponds to a biometric authentication system with a processor. The computer-implemented method includes a first step to train a biometric authentication system is learning continuously for authentication of one or more users based on user data and user behavior data. In addition, the training of the biometric authentication system is done to generate an authentication system. Further, the computer-implemented method includes a second step to trigger one or more hardware components. The one or more hardware components executes a pre-defined set of actions related to one or more financial technology organizations. Furthermore, the computer-implemented method includes a third step to receive the user data. The user data is received from the one or more users with the facilitation of one or more communication devices in real-time. Moreover, the computer-implemented method includes a fourth step to perform facial matching of the one or more users based on the user data of the one or more users. The facial matching of the one or more users is performed with the facilitation of one or more algorithms in real-time. Also, the computer-implemented method includes a fifth step to analyze the user data of the one or more users based on user data with the facilitation of the one or more algorithms. The analysis of the user data of the one or more users involves syncing and matching of the lips movement with the user data. The matching of the lips movement of the one or more users for the given text or phrase. The syncing of the audio feed and the video feed of the one or more users is done for determining authenticity of the one or more users in real-time. Also, the computer-implemented method includes a sixth step to receive a response to captcha given to the one or more users. The response to the captcha is received from the one or more communication devices in real-time. The response includes a received value associated with the captcha. Also, the computer-implemented method includes a seventh step to detect original user from the one or more users based on the user data and the user behavior data. The original user from the user is detected with the facilitation of the one or more algorithms in real-time. Also, the computer-implemented method includes an eighth step to send outcome upon detection of the detected original user from the one or more users to one or more financial technology organizations on the one or more communication devices in real-time.

In an embodiment of the present disclosure, the one or more communication devices are associated with the one or more hardware components for authentication of the one or more users. In addition, the one or more hardware components includes microphone, fingerprint sensor, dot projector, and optical devices. Further, the optical devices include video camera, photo camera, infrared camera, night vision camera, and thermal imaging camera.

In an embodiment of the present disclosure, the user data includes video samples, audio samples, facial movements, speaking pattern, and lips movements.

In an embodiment of the present disclosure, the video samples include past video recordings, and live video feed.

In an embodiment of the present disclosure, the audio samples include past audio recordings, and live audio feed.

In an embodiment of the present disclosure, the user behavior data includes user emotions, gestures, speaking behavior, and mood through real-time video and audio extraction.

In an embodiment of the present disclosure, the user data is received in one or more input formats. In addition, the one or more input formats include text data of the one or more users. Further, the text data includes security questions set by the one or more users and signature.

In an embodiment of the present disclosure, the system validates fingerprint and/or iris data of the one or more users. In addition, the fingerprint and iris data of the one or more users are examined using one or more algorithms in real-time.

In an embodiment of the present disclosure, the one or more financial technology organizations includes private organizations, public organizations, banking organizations, and technology security organizations.

In an embodiment of the present disclosure, the one or more algorithms includes decision tree machine learning algorithm, random forest machine learning algorithm, and naive bayes classifier machine learning algorithm. In addition, the one or more algorithms include support vector machine learning algorithm, k-nearest neighbors machine learning algorithm, and linear regression machine learning algorithm.

In a second example, a computer system is provided. The computer system includes one or more processors, a signal generator circuitry embedded inside a computing device for generating a signal, and a memory. The memory is coupled to the one or more processors. The memory stores instructions. The instructions are executed by the one or more processors. The execution of the instructions causes the one or more processors to perform a method for automated user authentication based on video and audio feed in real-time. The computer implemented method corresponds to a biometric authentication system. The computer-implemented method includes a first step to train a biometric authentication system is learning continuously for authentication of one or more users based on user data and user behavior data. In addition, the training of the biometric authentication system is done to generate an authentication system. Further, the computer-implemented method includes a second step to trigger one or more hardware components. The one or more hardware components executes a pre-defined set of actions related to one or more financial technology organizations. Furthermore, the computer-implemented method includes a third step to receive the user data. The user data is received from the one or more users with the facilitation of one or more communication devices in real-time. The user data is received in one or more input formats. The one or more input formats includes text data of the one or more users. The text data includes security questions set by the one or more users and signature. Moreover, the computer-implemented method includes a fourth step to perform facial matching of the one or more users based on the user data of the one or more users. The facial matching of the one or more users is performed with the facilitation of one or more algorithms in real-time. Also, the computer-implemented method includes a fifth step to analyze the user data of the one or more users based on user data with the facilitation of the one or more algorithms. The analysis of the user data of the one or more users involves syncing and matching of the lips movement with the user data. The matching of the lips movement of the one or more users for the given text or phrase. The syncing of the audio feed and the video feed of the one or more users is done for determining authenticity of the one or more users in real-time. Also, the computer-implemented method includes a sixth step to receive a response to captcha given to the one or more users. The response to the captcha is received from the one or more communication devices in real-time. The response includes a received value associated with the captcha. Also, the computer-implemented method includes a seventh step to detect original user from the one or more users based on the user data and the user behavior data. The original user from the user is detected with the facilitation of the one or more algorithms in real-time. Also, the computer-implemented method includes an eighth step to send outcome upon detection of the detected original user from the one or more users to one or more financial technology organizations on the one or more communication devices in real-time.

In an embodiment of the present disclosure, the one or more communication devices are associated with one or more hardware components for authentication of the one or more users. In addition, the one or more hardware components include microphone, fingerprint sensor, dot projector, and optical devices. Further, the optical devices include video camera, photo camera, infrared camera, night vision camera, and thermal imaging camera.

In an embodiment of the present disclosure, the user data includes video samples, audio samples, facial movements, speaking pattern, and lips movements.

In an embodiment of the present disclosure, the video samples include past video recordings, and live video feed.

In an embodiment of the present disclosure, the audio samples include past audio recordings, and live audio feed.

In an embodiment of the present disclosure, the user behavior data includes user emotions, gestures, speaking behavior, and mood through real-time video and audio extraction.

In an embodiment of the present disclosure, the computer-implemented method includes another step of validating fingerprint and/or iris data of the one or more users. In addition, the fingerprint and iris data of the one or more users are examined using one or more algorithms in real-time.

In an embodiment of the present disclosure, the one or more financial technology organizations include private organizations, public organizations, banking organizations, and technology security organizations.

In an embodiment of the present disclosure, the one or more algorithms include decision tree machine learning algorithm, random forest machine learning algorithm, and naive bayes classifier machine learning algorithm. In addition, the one or more algorithms include support vector machine learning algorithm, k-nearest neighbors machine learning algorithm, and linear regression machine learning algorithm.

In a third example, a non-transitory computer-readable storage medium is provided. The non-transitory computer-readable storage medium encodes computer executable instructions that, when executed by at least one processor, performs a method for automated user authentication based on video and audio feed in real-time. The computer implemented method corresponds to a biometric authentication system. The computer-implemented method includes a first step to train a biometric authentication system is learning continuously for authentication of one or more users based on user data and user behavior data. In addition, the training of the biometric authentication system is done to generate an authentication system. Further, the computer-implemented method includes a second step to trigger one or more hardware components. The one or more hardware components executes a pre-defined set of actions related to one or more financial technology organizations. Furthermore, the computer-implemented method includes a third step to receive the user data. The user data is received from the one or more users with the facilitation of one or more communication devices in real-time. The user data is received in one or more input formats. The one or more input formats includes text data of the one or more users. The text data includes security questions set by the one or more users and signature. In addition, the user data includes video samples, audio samples, facial movements, speaking pattern, and lips movements. The video samples include past video recordings, and live video feed. The audio samples include past audio recordings, and live audio feed. Moreover, the computer-implemented method includes a fourth step to perform facial matching of the one or more users based on the user data of the one or more users. The facial matching of the one or more users is performed with the facilitation of one or more algorithms in real-time. Also, the computer-implemented method includes a fifth step to analyze the user data of the one or more users based on user data with the facilitation of the one or more algorithms. The analysis of the user data of the one or more users involves syncing and matching of the lips movement with the user data. The matching of the lips movement of the one or more users for the given text or phrase. The syncing of the audio feed and the video feed of the one or more users is done for determining authenticity of the one or more users in real-time. Also, the computer-implemented method includes a sixth step to receive a response to captcha given to the one or more users. The response to the captcha is received from the one or more communication devices in real-time. The response includes a received value associated with the captcha. Also, the computer-implemented method includes a seventh step to detect original user from the one or more users based on the user data and the user behavior data. The user behavior data includes user emotions, gestures, speaking behavior, and mood through real-time video and audio extraction. Further, the original user from the user is detected with the facilitation of the one or more algorithms in real-time. Also, the computer-implemented method includes an eighth step to send outcome upon detection of the detected original user from the one or more users to one or more financial technology organizations on the one or more communication devices in real-time. The one or more financial technology organizations includes private organizations, public organizations, banking organizations, and technology security organizations.

### BRIEF DESCRIPTION OF THE FIGURES

Having thus described the disclosure in general terms, reference will now be made to the accompanying figures, wherein;

FIG. 1 illustrates an interactive computing environment for automated user authentication based on video feed and audio feed in real-time, in accordance with various embodiments of the present disclosure;

FIGS. 2A and 2B illustrate a flowchart for automated user authentication based on the video and the audio feed in real-time, in accordance with various embodiments of the present disclosure; and

FIG. 3 illustrates a block diagram of a computing device, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

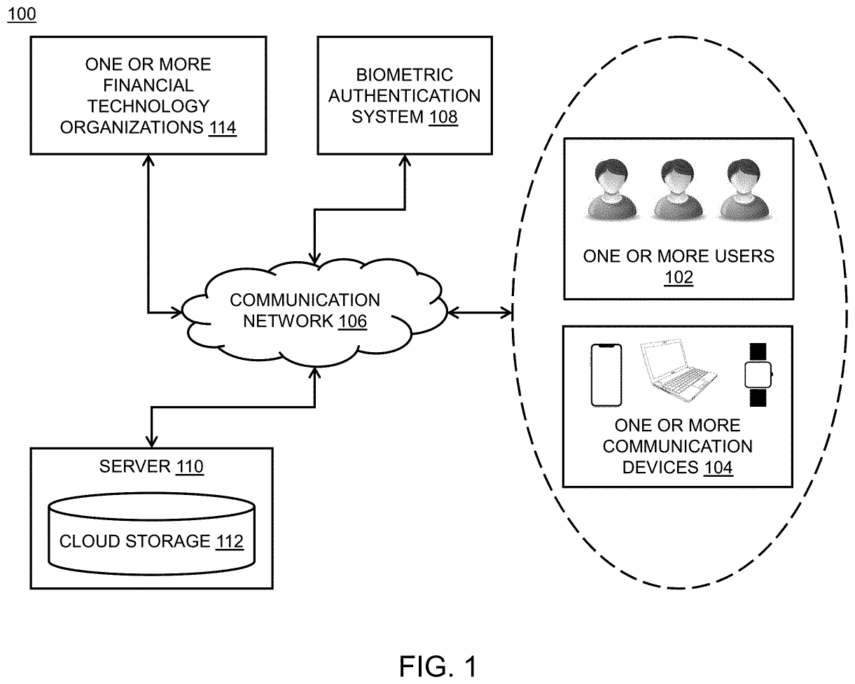

FIG. 1 illustrates an interactive computing environment 100 for automated user authentication based on video feed and audio feed in real-time in accordance with various embodiments of the present disclosure. The interactive computing environment 100 shows a relationship between various entities involved in the authentication of the user identity for detecting potential variations in real-time.

The interactive computing environment 100 includes one or more users 102, one or more communication devices 104, a communication network 106. In addition, the interactive computing environment 100 includes a biometric authentication system 108, a server 110, a cloud storage 112, and one or more financial technology organizations 114. The above-stated elements of the interactive computing environment 100 operates coherently and synchronously. In an embodiment of the present disclosure, the interactive computing environment 100 is configured to the authentication of the user identity for detecting potential variations in real-time.

The interactive computing environment 100 is associated with the one or more users 102. The one or more users 102 may be any person or an individual wants to access his/her account on the financial technology platform. In addition, the one or more users 102 may be any person or an individual looking for his/her to get verified. In an example, a user U1 wants to operate his/her account managed by banking institution B1. Further, the biometric authentication system 108 authenticates the user U1 identity in real-time to grant access to his/her account. In an embodiment of the present disclosure, the one or more users 102 is associated with the one or more communication devices 104. In another example, the one or more users 102 is an owner of the one or more communication devices 104. In another example, the one or more users 102 may not be the owner of the one or more communication devices 104. In another embodiment of the present disclosure, the one or more users 102 may be a person who wants to verify his/her identity from the biometric authentication system 108. In yet another embodiment of the present disclosure, the one or more users 102 may be any person. In yet another embodiment of the present disclosure, the one or more users 102 may interact with the biometric authentication system 108 directly through the one or more communication devices 104. In some cases, the one or more users 102 may interact with the biometric authentication system 108 via the one or more communication devices 104 through the communication network 106.

Further, the communication network 106 denotes to channels of communication (networks by which information flows). Small networks, which are used for connection to the subgroup and are usually contained in a piece of equipment. The local area network, or LAN, cable or fiber, is used to connect computer equipment and other terminals distributed in the local area, such as in the university campus. The Metropolitan Area Network or MAN is a high-speed network that is used to connect a small geographical area such as a LAN across the city. Wide area networks, or any communication connections, including WAN, microwave radio link and satellite, are used to connect computers and other terminals to a larger geographic distance. In yet another embodiment of the present disclosure, the communication network 106 may be any type of network that provides internet connectivity to the biometric authentication system 108. In yet another embodiment of the present disclosure, the communication network 106 may be any type of network that provides internet connectivity to the one or more communication devices 104. In yet embodiment of the present disclosure, the communication network 106 is a wireless mobile network. In yet embodiment of the present disclosure, the communication network 106 is a wired network with finite bandwidth. In yet another embodiment of the present disclosure, the communication network 106 is a combination of the wireless and the wired network for optimum throughput of data transmission. In yet another embodiment of the present disclosure, the communication network 106 is an optical fiber high bandwidth network that enables high data rate with negligible connection drops. In yet another embodiment of the present disclosure, the communication network 106 provides medium for the one or more communication devices 104 to connect to the biometric authentication system 108. In this scenario, the communication network 106 may be a global network of computing devices such as the Internet.

The interactive computing environment 100 includes the one or more communication devices 104. Commonly, communication devices refer to equipment or device capable of transmitting analog or digital signals through communication wire or remote way. The best case of the media device is a PC modem, which is equipped for sending and getting analog or digital signals to enable PCs to converse with different PCs. In an embodiment of the present disclosure, the one or more communication devices 104 includes a computer, laptop, smart television, PDA, electronic tablet, smartphone, wearable devices, tablet, smartwatch, smart display, gesture-controlled devices, and the like. In an example, the one or more communication devices 104 displays, reads, transmits and gives output to the one or more users 102 in real-time. The one or more users 102 may access the one or more communication devices 104 while moving from one place to another place. In another example, the place includes home, park, restaurant, any facility, college, university, office and the like. In addition, the one or more users 102 may access the one or more communication devices 104 from inside and outside of the environment.

In general, communication devices are used for one or more purposes. In an example, the one or more purposes include communication, entertainment, accessing web-based platforms for different tasks and the like. In an embodiment of the present disclosure, the one or more communication devices 104 includes a mobile application. The mobile application is installed on the one or more communication devices 104. Generally, the mobile application performs various tasks such as handling notifications and connectivity. Also, the mobile application is programmed in different languages for different platforms. Moreover, the use of the mobile application in online mode and offline mode depends on the type of application used. In an example, the mobile applications are used for entertaining, productivity, marketing and accessing various e-commerce and web-based platforms.

In addition, the one or more communication devices 104 are associated with a camera, a global positioning system, keypad, touchscreen, and the like. The keypad gathers manual data input from the one or more users 102. In another embodiment of the present disclosure, the one or more communication devices 104 are connected to the biometric authentication system 108 with the facilitation of the communication network 106.

In an embodiment of the present disclosure, the one or more communication devices 104 are connected to the internet in real-time. Further, the one or more communication devices 104 is associated with a specific type of operating system. The specific type of operating system includes an android operating system, a windows operating system, a mac operating system and the like. Moreover, the one or more communication devices 104 are connected to the internet through the communication network 106. Further, the one or more communication devices 104 are connected to the internet through a data connection provided by a telecom service provider. The telecom service provider is associated with a subscriber identification module card located inside the one or more communication devices 104. Furthermore, the one or more communication devices 104 may be connected to the internet through a WiFi connection.

In an embodiment of the present disclosure, the one or more communication devices 104 is associated with the biometric authentication system 108. In addition, the one or more communication devices 104 is associated with the biometric authentication system 108 through the communication network 106. In another embodiment of the present disclosure, the one or more communication devices 104 is associated with the one or more financial technology organizations 114. Further, the one or more communication devices 104 is associated with the one or more financial technology organizations 114 through the communication network 106. In yet another embodiment of the present disclosure, the communication network 106 enables the one or more communication devices 104 to gain access to the internet. Moreover, the one or more communication devices 104 provides a medium for transferring information between the one or more communication devices 104 and the biometric authentication system 108. Also, the one or more communication devices 104 provides a medium for transferring information between the one or more communication devices 104 and the one or more financial technology organizations 114. Also, the medium for communication may be infrared, microwave, radio frequency (RF) and the like. In yet another embodiment of the present disclosure, the one or more communication devices 104 are associated with one or more hardware components for the one or more users 102 authentication. In an example, the one or more hardware components are associated with the one or more users 102 for pre-defined set of action items related to financial technologies space. In addition, the one or more hardware components include microphone, fingerprint sensor, dot projector, optical devices, and the like. Further, the optical devices include video camera, photo camera, infrared camera, night vision camera, thermal imaging camera, and the like.

The interactive computing environment 100 includes the biometric authentication system 108. The biometric authentication system 108 performs one or more steps to authenticate the user identity for detecting the potential variations. Also, the biometric authentication system 108 performs the one or more steps to facilitates the one or more financial technology organizations 114 for determining the authenticity of the one or more users 102 in real-time. In an embodiment of the present disclosure, the biometric authentication system 108 may ask the one or more users 102 to onboard various biometric parameters associated with the identity of the one or more users 102. In addition, the one or more users 102 may onboard various biometric parameters associated with the identity of the one or more users 102 with the facilitation of the one or more communication devices 104. The biometric authentication system 108 collects a plurality of information related to the one or more users 102. In addition, the plurality of information includes user name, user age, unique identification code, user image, user voice, user biometric details, quick response code, barcode, and the like.

In addition, the biometric authentication system 108 runs on one or more algorithms. In general, an algorithm is referred to as a procedure or formula for solving a problem based on conducting a sequence of specified actions. A computer program can be viewed as an elaborate algorithm. In mathematics and computer science, an algorithm usually means a small procedure that solves a recurrent problem. In an embodiment of the present disclosure, the one or more algorithms include decision tree machine learning algorithm, random forest machine learning algorithm, naive bayes classifier machine learning algorithm, support vector machine learning algorithm, k-nearest neighbors machine learning algorithm, linear regression machine learning algorithm, and the like.

The interactive computing environment 100 includes the one or more financial technology organizations 114. In general, financial technology organization is utilized to help companies, business owners and consumers better manage their financial operations, processes, and lives by utilizing specialized software and algorithms that are used on computers and, increasingly, smartphones. In addition, the one or more financial technology organizations 114 includes private organizations, public organizations, banking organizations, technology security organizations, and the like.

The interactive computing environment 100 includes the server 110. In an embodiment of the present disclosure, the biometric authentication system 108 is associated with the server 110. In an embodiment of the present disclosure, the one or more financial technology organizations 114 is associated with the server 110. In yet another embodiment of the present disclosure, the one or more communication devices 104 is associated with the server 110. In yet another embodiment of the present disclosure, the biometric authentication system 108 is installed at the server 110. In yet another embodiment of the present disclosure, the biometric authentication system 108 is installed at a plurality of servers. In general, a server refers to a computer that provides data to other computers. It may serve data to systems on a local area network (LAN) or a wide area network (WAN) over the Internet. Many types of servers exist, including web servers, mail servers, file servers, and the like. Each type of server runs software specific to the purpose of the server. For example, a Web server may run Apache HTTP Server or Microsoft IIS, which both provide access to websites over the Internet. A mail server may run a program like Exim or I Mail, which provides SMTP services for sending and receiving the email. A file server might use Samba or the operating system's built-in file-sharing services to share files over a network. While server software is specific to the type of server, the hardware is not as important. In fact, a regular desktop computer can be turned into a server by adding the appropriate software. For example, a computer connected to a home network can be designated as a file server, print server, or both. In another example, the plurality of servers may include a database server, file server, application server and the like. The plurality of servers communicates with each other using the communication network 106.

The interactive computing environment 100 includes the cloud storage 112. Generally, a cloud platform refers to a data structure that stores organized information. Most cloud platforms contain multiple tables, which may each include several different fields. For example, the cloud platform 112 may include records related to user demographic data, user social data, user location, legal document information of the one or more users 102, and the like. Each of these tables would have different fields that are relevant to the information stored in the table. In an embodiment of the present disclosure, one or more user profiles are stored on the cloud platform 112. In addition, the one or more user profiles available on the one or more web-based platforms may include data and information of the one or more users 102 available on the one or more social networking platforms. In an example, the social networking platform includes Facebook, Instagram, LinkedIn, Twitter, and the like. In another embodiment of the present disclosure, the data available on the one or more web-based platforms is the data filled by the one or more users 102 in past time. In an example, the one or more users 102 updates the data on the one or more web-based platforms on a regular basis.

In an embodiment of the present disclosure, the biometric authentication system 108 is trained continuously to learning to authenticate the one or more users 102 based on the user data and user behavior data. The user behavior data includes user emotions, gestures, speaking behavior, and mood through real-time video and audio extraction. In addition, the user data includes video samples, audio samples, facial movements, speaking pattern, lips movements, and the like. In another embodiment of the present disclosure, biometric authentication system 108 triggers the one or more hardware components. The one or more hardware components executes a pre-defined set of actions related to the one or more financial technology organizations.

In an embodiment of the present disclosure, the biometric authentication system 108 receives the user data. The user data is received from the one or more users 102 with the facilitation of the one or more communication devices 104. In addition, the user data is received in real-time. In another embodiment of the present disclosure, the biometric authentication system 108 validates fingerprint and/or iris data of the one or more users 102. Further, the fingerprint and/or iris data of the one or more users 102 are examined using one or more algorithms in real-time. For example, user U2 scans his/her right-hand thumb on scanner S1 to get his/her biometric identity verified in real-time.

In an embodiment of the present disclosure, the biometric authentication system 108 analysis the user data of the one or more users 102 based on the user data with the facilitation of the one or more algorithms. In an example, the biometric authentication system 108 performs matching of user U3 for his/her eyes shape, nose shape and length, face shape, and the like. Further the biometric authentication system 108 performs matching of the lips movement of the one or more users 102 for given text or phrase. The lips movement of the one or more users 102 is received from the video feed recorded on the one or more communication devices 104 in real-time. The matching of the lips movement of the one or more users 102 is based on the user data of the one or more users 102. Furthermore, the biometric authentication system 108 syncing the audio feed with the video feed of the one or more users 102. The syncing of the audio feed and the video feed of the one or more users 102 is done for determining authenticity of the one or more users 102 in real-time. The syncing of the audio feed and the video feed of the one or more users 102 is performed with the facilitation of one or more algorithms in real-time. In another embodiment of the present disclosure, the user data is received in one or more input formats. The one or more input formats include text data of the one or more users 102. In addition, the text data includes security questions set by the one or more users 102, signature, and the like. In an example, the video samples may include past video recordings and live video feed. In another example, the audio samples may include past audio recordings and live audio feed.

In an embodiment of the present disclosure, the biometric authentication system 108 receives a response to captcha given to the one or more users 102. In general, captcha stands for completely automated public turing test to tell computers and humans apart. In addition, captcha determines whether the user is real or a spam robot. Captchas stretch or manipulate letters and numbers, and rely on human ability to determine which symbols they are. In another embodiment of the present disclosure, the response to the captcha is received from the one or more communication devices 104 in real-time. The response including a received value associated with the captcha. Further, the biometric authentication system 108 performs facial matching of the one or more users 102 based on the user data of the one or more users 102. The facial matching of the one or more users 102 is performed with the facilitation of the one or more algorithms in real-time.

In an embodiment of the present disclosure, the biometric authentication system 108 detects original user from the one or more users 102 based on the user data and the user behavior data. In addition, the original user from the one or more users 102 is detected with the facilitation of the one or more algorithms in real-time. In another embodiment of the present disclosure, the biometric authentication system 108 sends an outcome of the detected original user from the one or more users 102 to one or more financial technology organizations. For example, the one or more financial technology organizations 114 includes private organizations, public organizations, banking organizations, technology security organizations, and the like. In addition, the biometric authentication system 108 sends the outcome upon detection of the original user from the one or more users 102 to one or more financial technology organizations on the one or more communication devices 104 in real-time. For example, user U5 approach bank B2 for operating an account number A10082019. The biometric authentication system 108 detects that the account number A10082019 does not belong to the user U5 and the user U5 is pretending to be the original owner of the account number A10082019 based on the user data and the user behaviour data. In this case, the biometric authentication system 108 intimates the bank B2 for the potential deceit by the user U5.

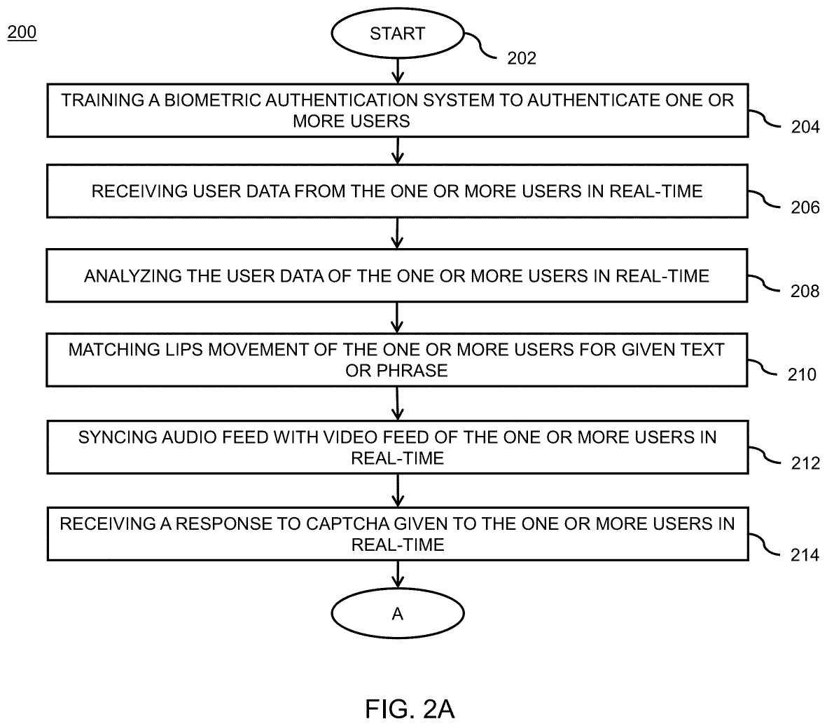

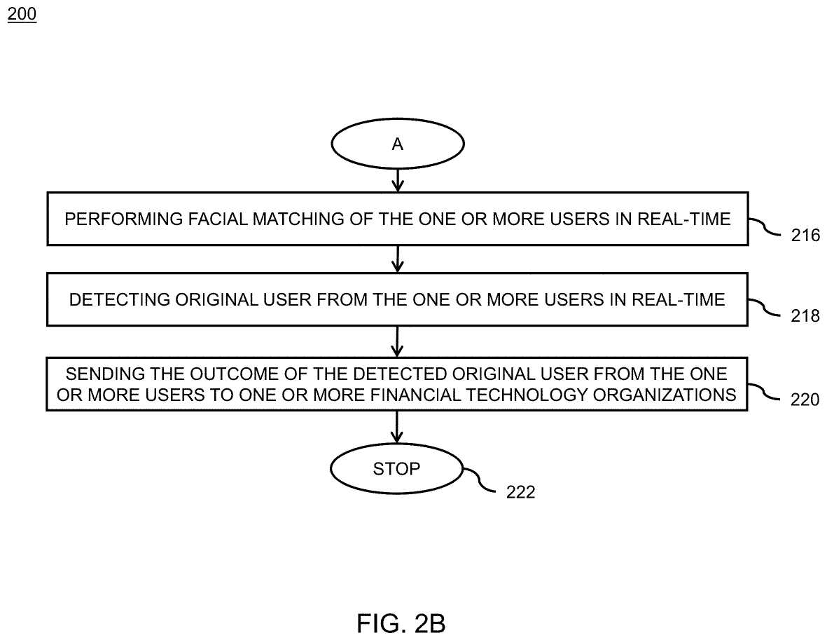

FIGS. 2A and 2B are a flowchart 200 for automated user authentication based on the video and the audio feed in real-time in accordance with various embodiments of the present disclosure. The flowchart 200 initiates at step 202. Following step 202, at step 204 the biometric authentication system 108 trained to authenticate the one or more users 102. At step 206, the biometric authentication system 108 receives the user data from the one or more users 102 in real-time. At step 208, the biometric authentication system 108 analysis the user data of the one or more users 102 in real-time. At step 210, the biometric authentication system 108 performs matching of the lips movement of the one or more users 102 for the given text or the phrase. At step 212, the biometric authentication system 108 performs syncing of the audio feed with the video feed of the one or more users 102 in real-time. At step 214, the biometric authentication system 108 receives the response to the captcha given to the one or more users 102 in real-time. The one or more parameters are significant for adopting the final route from the one or more routes. At step 216, the biometric authentication system 108 performs the facial matching of the one or more users 102 in real-time. At step 218, the biometric authentication system 108 detects original user from the one or more users 102 in real-time. At step 220, the biometric authentication system 108 sends the outcome of the detected original user from the one or more users 102 to the one or more financial technology organizations 114. The flow chart 200 terminates at step 222.

It may be noted that the flowchart 200 is explained to have above stated process steps; however, those skilled in the art would appreciate that the flowchart 200 may have more/less number of process steps which may enable all the above-stated embodiments of the present disclosure.

The image recognition search system 108 may be implemented using a single computing device, or a network of computing devices, including cloud-based computer implementations. The computing devices are preferably server class computers including one or more high-performance computer processors and random-access memory and running an operating system such as LINUX or variants thereof. The operations of the image recognition search system 108 as described herein can be controlled through either hardware or through computer programs installed in a non-transitory computer-readable storage devices such as solid-state drives or magnetic storage devices and executed by the processors to perform the functions described herein. The cloud storage 112 is implemented using non-transitory computer-readable storage devices, and suitable database management systems for data access and retrieval. The image recognition search system 108 includes other hardware elements necessary for the operations described herein, including network interfaces and protocols, input devices for data entry, and output devices for display, printing, or other presentations of data. Additionally, the operations listed here are necessarily performed at such a frequency and over such a large set of data that they must be performed by a computer in order to be performed in a commercially useful amount of time, and thus cannot be performed in any useful embodiment by mental steps in the human mind.

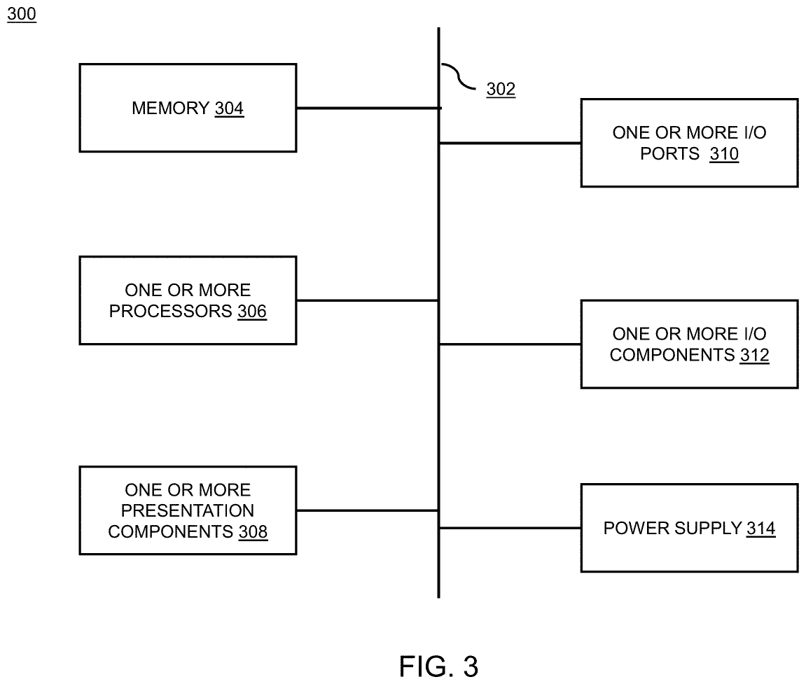

FIG. 3 illustrates a block diagram of the device 300, in accordance with various embodiments of the present disclosure. The device 300 includes a bus 302 that directly or indirectly couples the following devices: memory 304, one or more processors 306, one or more presentation components 308, one or more input/output (I/O) ports 310, one or more input/output components 312, and an illustrative power supply 314. The bus 302 represents what may be one or more busses (such as an address bus, data bus, or combination thereof). Although the various blocks of FIG. 3 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 3 is merely illustrative of an exemplary device 300 that can be used in connection with one or more embodiments of the present invention. The distinction is not made between such categories as “workstation,” “server,” “laptop,” “hand-held device,” etc., as all are contemplated within the scope of FIG. 3 and reference to “computing device.”

The device 300 typically includes a variety of computer-readable media. The computer-readable media can be any available media that can be accessed by the device 300 and includes both volatile and nonvolatile media, removable and non-removable media. By way of example, and not limitation, the computer-readable media may comprise computer storage media and communication media. The computer storage media includes volatile and nonvolatile, removable and non-removable media implemented in any method or technology for storage of information such as computer-readable instructions, data structures, program modules or other data. The computer storage media includes, but is not limited to, non-transitory computer-readable storage medium that stores program code and/or data for short periods of time such as register memory, processor cache and random access memory (RAM), or any other medium which can be used to store the desired information and which can be accessed by the device 300. The computer storage media includes, but is not limited to, non-transitory computer readable storage medium that stores program code and/or data for longer periods of time, such as secondary or persistent long term storage, like read-only memory (ROM), EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the device 300. The communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 304 includes computer-storage media in the form of volatile and/or nonvolatile memory. The memory 304 may be removable, non-removable, or a combination thereof. Exemplary hardware devices include solid-state memory, hard drives, optical-disc drives, etc. The device 300 includes the one or more processors 306 that read data from various entities such as memory 304 or I/O components 312. The one or more presentation components 308 present data indications to the user 102 or another device. Exemplary presentation components include a display device, speaker, printing component, vibrating component, etc. The one or more I/O ports 310 allow the device 300 to be logically coupled to other devices including the one or more I/O components 312, some of which may be built-in. Illustrative components include a microphone, joystick, gamepad, satellite dish, scanner, printer, wireless device, etc.

The foregoing descriptions of pre-defined embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed:

1. A computer-implemented method for automated user authentication based on video feed and audio feed in real-time, the computer-implemented method comprising:
training, at a biometric authentication system with a processor, the biometric authentication system to learn continuously for authentication of one or more users based on user data and user behavior data;
triggering, at the biometric authentication system with the processor, one or more hardware components associated with one or more communication devices, wherein the one or more hardware components executes a pre-defined set of actions related to one or more financial technology organizations;
receiving, at the biometric authentication system with the processor, the user data in real-time, wherein the user data is received from the one or more users with facilitation of the one or more communication devices;
analyzing, at the biometric authentication system with the processor, the user data of the one or more users with facilitation of one or more algorithms, wherein the analyzed user data of the one or more users is stored on cloud platform in real-time;
matching, at the biometric authentication system with the processor, lips movement of the one or more users for given text or phrase, wherein the lips movement of the one or more users is received from a video feed recorded on the one or more communication devices in real-time, wherein the matching of the lips movement of the one or more users is based on the user data of the one or more users;
syncing, at the biometric authentication system with the processor, an audio feed with the video feed of the one or more users, wherein the syncing of the audio feed and the video feed of the one or more users is done for determining authenticity of the one or more users in real-time, wherein the syncing of the audio feed and the video feed of the one or more users is performed with the facilitation of the one or more algorithms in real-time;
receiving, at the biometric authentication system, a response to captcha given to the one or more users, wherein the response to the captcha is received from the one or more communication devices in real-time, wherein the response comprises a received value associated with the captcha;
performing, at the biometric authentication system with the processor, facial matching of the one or more users based on the user data of the one or more users, wherein the facial matching of the one or more users is performed with the facilitation of the one or more algorithms in real-time;
detecting, at the biometric authentication system with the processor, original user from the one or more users based on the user data and the user behavior data, wherein the original user from the one or more users is detected with the facilitation of the one or more algorithms in real-time; and
sending, at the biometric authentication system with the processor, outcome upon detection of the original user from the one or more users to the one or more financial technology organizations on the one or more communication devices in real-time.

2. The computer-implemented method as recited in claim 1, wherein the one or more communication devices are associated with the one or more hardware components for authentication of the one or more users, wherein the one or more hardware components comprises microphone, fingerprint sensor, dot projector, and optical devices, wherein the optical devices comprises video camera, photo camera, infrared camera, night vision camera, and thermal imaging camera.

3. The computer-implemented method as recited in claim 1, wherein the user data comprises video samples, audio samples, facial movements, speaking pattern, and lips movements.

4. The computer-implemented method as recited in claim 3, wherein the video samples comprises past video recordings, and live video feed.

5. The computer-implemented method as recited in claim 3, wherein the audio samples comprises past audio recordings, and live audio feed.

6. The computer-implemented method as recited in claim 1, wherein the user behavior data comprises user emotions, gestures, speaking behavior, and mood through real-time video and audio extraction.

7. The computer-implemented method as recited in claim 1, wherein the user data is received in one or more input formats, wherein the one or more input formats comprises text data of the one or more users, wherein the text data comprises security questions set by the one or more users and signature.

8. The computer-implemented method as recited in claim 1, further comprising:
validating, at the biometric authentication system with the processor, at least one of fingerprint data and iris data of the one or more users, wherein the fingerprint and iris data of the one or more users are examined using the one or more algorithms in real-time.

9. The computer-implemented method as recited in claim 1, wherein the one or more financial technology organizations comprises private organizations, public organizations, banking organizations, and technology security organizations.

10. The computer-implemented method as recited in claim 1, wherein the one or more algorithms comprises decision tree machine learning algorithm, random forest machine learning algorithm, naive bayes classifier machine learning algorithm, support vector machine learning algorithm, k-nearest neighbors machine learning algorithm, and linear regression machine learning algorithm.

11. A computer system comprising:
one or more processors; and
a memory coupled to the one or more processors, the memory for storing instructions which, when executed by the one or more processors, cause the one or more processors to perform a method for automated user authentication based on video and audio feed in real-time, the method comprising:
training, at a biometric authentication system, the biometric authentication system to learn continuously for authentication of one or more users based on user data and user behavior data;
triggering, at the biometric authentication system, one or more hardware components associated with one or more communication devices, wherein the one or more hardware components executes a pre-defined set of actions related to one or more financial technology organizations;
receiving, at the biometric authentication system, the user data in real-time, wherein the user data is received from the one or more users with facilitation of the one or more communication devices;
analyzing, at the biometric authentication system, the user data of the one or more users with facilitation of one or more algorithms, wherein analyzed user data of the one or more users is stored on cloud platform in real-time;
matching, at the biometric authentication system, lips movement of the one or more users for given text or phrase, wherein the lips movement of the one or more users is received from a video feed recorded on the one or more communication devices in real-time, wherein the matching of the lips movement of the one or more users is based on the user data of the one or more users;
syncing, at the biometric authentication system, an audio feed with the video feed of the one or more users, wherein the syncing of the audio feed and the video feed of the one or more users is done for determining authenticity of the one or more users in real-time, wherein the syncing of the audio feed and the video feed of the one or more users is performed with the facilitation of the one or more algorithms in real-time;
receiving, at the biometric authentication system, a response to captcha given to the one or more users, wherein the response to the captcha is received from the one or more communication devices in real-time, wherein the response comprises a received value associated with the captcha;
performing, at the biometric authentication system, facial matching of the one or more users based on the user data of the one or more users, wherein the facial matching of the one or more users is performed with the facilitation of the one or more algorithms in real-time;
detecting, at the biometric authentication system, original user from one or more users based on the user data and the user behavior data, wherein the original user from the one or more users is detected with the facilitation of the one or more algorithms in real-time; and
sending, at the biometric authentication system, outcome upon detection of the original user from the one or more users to the one or more financial technology organizations on the one or more communication devices in real-time.

12. The computer system as recited in claim 11, wherein the one or more hardware components comprises microphone, fingerprint sensor, dot projector, and optical devices, wherein the optical devices comprises video camera, photo camera, infrared camera, night vision camera, and thermal imaging camera.

13. The computer system as recited in claim 11, wherein the user data comprises video samples, audio samples, facial movements, speaking pattern, and lips movements.

14. The computer system as recited in claim 13, wherein the video samples comprises past video recordings, and live video feed.

15. The computer system as recited in claim 13, wherein the audio samples comprises past audio recordings, and live audio feed.

16. The computer system as recited in claim 11, wherein the user behavior data comprises user emotions, gestures, speaking behavior, and mood through real-time video and audio extraction.

17. The computer system as recited in claim 11, further comprising:
validating, at the biometric authentication system with the processor, at least one of fingerprint and iris data of the one or more users, wherein the fingerprint and iris data of the one or more users are examined using the one or more algorithms in real-time.

18. The computer system as recited in claim 11, wherein the one or more financial technology organizations comprises private organizations, public organizations, banking organizations, and technology security organizations.

19. The computer system as recited in claim 11, wherein the one or more algorithms comprises decision tree machine learning algorithm, random forest machine learning algorithm, naive bayes classifier machine learning algorithm, support vector machine learning algorithm, k-nearest neighbors machine learning algorithm, and linear regression machine learning algorithm.

20. A non-transitory computer-readable storage medium encoding computer executable instructions that, when executed by at least one processor, perform a method for automated user authentication based on video and audio feed in real-time, the method comprising:
training, at a biometric authentication system, the biometric authentication system to learn continuously for authentication of one or more users based on user data and user behavior data;
triggering, at the biometric authentication system, one or more hardware components associated with one or more communication devices, wherein the one or more hardware components executes a pre-defined set of actions related to one or more financial technology organizations;
receiving, at the biometric authentication system, the user data in real-time, wherein the user data is received from the one or more users with facilitation of the one or more communication devices, wherein the user behavior data comprises user emotions, gestures, speaking behavior, and mood through real-time video and audio extraction;
analyzing, at the biometric authentication system, the user data of the one or more users with facilitation of one or more algorithms, wherein the analyzed user data of the one or more users is stored on cloud platform in real-time;
matching, at the biometric authentication system, lips movement of the one or more users for given text or phrase, wherein the lips movement of the one or more users is received from a video feed recorded on the one or more communication devices in real-time, wherein the matching of the lips movement of the one or more users is based on the user data of the one or more users;
syncing, at the biometric authentication system, an audio feed of the one or more users with the video feed of the one or more users, wherein the syncing of the audio feed of the one or more users and the video feed of the one or more users is done for determining authenticity of the one or more users in real-time, wherein the syncing of the audio feed and the video feed of the one or more users is performed with the facilitation of the one or more algorithms in real-time;
receiving, at the biometric authentication system, a response to captcha given to the one or more users, wherein the response to the captcha is received from the one or more communication devices in real-time, wherein the response comprises a received value associated with the captcha;
performing, at the biometric authentication system, facial matching of the one or more users based on the user data of the one or more users, wherein the facial matching of the one or more users is performed with the facilitation of the one or more algorithms in real-time;
detecting, at the biometric authentication system, original user from the one or more users based on the user data and the user behavior data, wherein the original user from the one or more users is detected with the facilitation of the one or more algorithms in real-time; and
sending, at the biometric authentication system, outcome upon detection of the original user from the one or more users to the one or more financial technology organizations on the one or more communication devices in real-time.
